(19) United States
(12) Patent Application Publication
(10) Pub. No.: US 2011/0116686 A1
(43) Pub. Date: May 19, 2011

(54) VIDEO TOLLING SYSTEM WITH ERROR CHECKING

(75) Inventor: Kelly Gravelle, Poway, CA (US)

(73) Assignee: TC LICENSE LTD., Hummelstown, PA (US)

(21) Appl. No.: 12/944,033

(22) Filed: Nov. 11, 2010

Related U.S. Application Data
(60) Provisional application No. 61/261,254, filed on Nov. 13, 2009.

(51) Int. Cl. G06K 9/00

(52) U.S. Cl. 382/105

(57) ABSTRACT

An automated toll collection system based on visual recognition of a license plate with a supplemental enhancement to confirm the character recognition of the license plate is disclosed. In an embodiment, a supplemental graphic insignia encodes a check-sum for the license plate characters. The insignia is recorded at the same time as the license plate and the check sum is decoded to confirm the interpretation of the characters on the license plate. Other forms of confirmation devices are also disclosed, including RFID devices.

### CROSS-REFERENCE TO RELATED APPLICATIONS

This utility application claims the benefit under 35 U.S.C. §119(e) of Provisional Application Ser. No. 61/261,254, filed on Nov. 13, 2009 and entitled Video Tolling System with Error Checking The entire disclosure of this application is incorporated by reference herein.

### FIELD OF THE INVENTION

The invention relates generally to the field of automated toll collection and more specifically to toll collection employing video identification of the toll user.

### BACKGROUND OF THE INVENTION

Electronic Toll Collection (ETC) systems operate typically as a combination of multiple technologies. A basic ETC system includes a vehicle classification system, an RFID system to identify vehicles based on tags mounted on or in those vehicles, a vehicle separator that is used to determine the start and stop points for vehicles as they pass through the lanes, and a video enforcement/tolling system.

Two categories of vehicles will appear on the toll road, tagged and untagged vehicles. When a tagged vehicle approaches the toll point, the vehicle's tag is read by the RFID system and the classification is determined by the classification system. A transaction including at least the tag ID and usually also the vehicle class is formed and sent to a back office where an account associated with the tag ID is charged the toll amount corresponding to the toll agency's business rules.

If a tag is not present (untagged vehicle), a camera is triggered to take one or more photos of the rear license plate of the vehicle. The image is then processed manually or automatically or both to extract the license plate number. The toll authority then typically obtains the vehicle owner information and can issue a toll violation citation to the vehicle owner. Many toll agencies also associate the one or more vehicle license plate numbers to an account in addition to the tag ID, and therefore if a plate is read, the plate number is first looked up in the authority's database to determine if the plate is associated with an account and the account is charged the associated toll (and sometimes a surcharge) to the account associated with the plate number. This process is typically called a Video Toll or VTOLL transaction. Some agencies will also look up DMV data on plates for which they don't have accounts, and then issue bills to the registered vehicle owner (sometimes plus a service fee or surcharge) provided they have the legal authority to do so.

In some cases toll agencies will trigger and retain and or process images of license plates from all vehicles, but will segregate the transactions into tag and VTOLL transactions. In either case, the VTOLL transaction acts as a supplementary method of toll collection rather than simply an automated method of enforcing the use of RFID tags by motorists using the toll facility. VTOLLs have the advantage that they capture toll payments from vehicles that do not have RFID tags. This helps in cases where tags are not read because they are mis-mounted, have dead batteries, or are lost or forgotten. It is also useful to capture toll payments from “casual users” users who have decided for whatever reason not to sign up for an account and obtain a toll tag. VTOLLS can also be a very important component of ETC system collections in an open road tolling (ORT) environment where no cash collection option exists. Casual users can still use the roadway, and revenue from these users can be collected using VTOLLS. VTOLLS therefore become an enabler for ORT implementations that eliminate the need for cash collections, which has several well known advantages to toll operators, including lower operating costs and enhanced traffic flow.

However VTOLLS also suffer from issues that limit their applicability beyond a supplemental collection role in ETC system. One significant issue is the propensity for Optical Character Recognition (OCR) systems, used to automatically read the license plate number, to make mistakes in reading the plate number. This misread rate is crucial since every misread of a license plate number used to generate a VTOLL transaction has the potential to cause the incorrect person to be billed for a toll. This is a very serious situation as such errors erode the credibility of the toll billing system. As a result, only an extremely low false read rate can be tolerated in VTOLL systems. To cope with this, most VTOLL systems today require a significant amount of manual (human) review of license plate images to filter out such potential errors. This adds significant cost to the VTOLL process thus making it less attractive as a toll collection method, and generally limiting its role to a supplementary method of collection.

Prior art systems try to deal with this issue by employing quality measurements on the image and plate read to establish quality factors. These quality factors are used to estimate a confidence in the accuracy of the automatic plate read. This estimate is used to eliminate manual processing of high confidence reads before they are used to generate a VTOLL transaction, thus reducing the average cost of VTOLL processing. Other systems enhance this strategy by learning the “fingerprint” of the vehicle associated with a given plate over time. This fingerprint is a composite representation of other image characteristics of the vehicle. If a plate is read and the collected “fingerprint” data of the vehicle image matches the historically collected fingerprint data on this particular plate, higher confidence can be assigned to the plate read and thus may bypass costly manual review.

However, such “fingerprint” based systems still suffer from limitations. For one, they rely on obtaining previous image data on the vehicle, which may not be a viable strategy for vehicles that make infrequent use of the toll facility. Such systems also rely on whatever image characteristics exist to form an effective fingerprint, and this can vary from vehicle to vehicle and also with environmental conditions, lane geometry, and lighting conditions. As a result such systems are not very deterministic and still result in a significant number of images that require manual processing.

Thus a need exists for a robust system for enhancing the accuracy of license-plate based video tolling systems.

### SUMMARY OF THE INVENTION

An automated toll collection system is disclosed having a camera, a vehicle having a license plate comprising alpha-numeric characters and a graphic insignia. The graphic insignia represents a numeric value associated with the alpha-numeric characters. The video camera records both the license plate and the graphic insignia to identify the vehicle for tolling purposes. The graphic insignia serves as an enhancement to confirm the interpreted value of the license plate. In an embodiment, the insignia is a bar code representing a check sum of at least a portion of the characters on the license plate. In a further embodiment, the camera is a video camera.

In a further embodiment, the graphic insignia is an encoded number derived from a portion of the alpha-numeric characters on the license plate. In a further embodiment, the encoded number is a cyclic redundancy check of a portion of said alpha-numeric characters on the license plate. In a further embodiment, the graphic insignia is located on said license plate. In a further embodiment, the graphic insignia comprises a retro-reflective decal. In a further embodiment, the graphic insignia is located inside a window of the vehicle and visible from the outside of the vehicle. In a further embodiment, the graphic is a barcode, a two-dimensional coded data matrix, or a bokode.

A method of automated toll collection is also disclosed, the method including the steps of: providing a vehicle with a license plate having alpha-numeric characters; providing the vehicle with a supplemental device encoding a numeric value related to a portion of the alpha-numeric characters; recording an image of the alpha-numeric characters with a camera; using optical character recognition to produce an optical character recognition result from the recorded image; and confirming the optical character recognition by comparing the optical character recognition result with the numeric value related to the portion of the alpha-numeric characters. In an embodiment of the method, the supplemental device is a graphicinsignia. In a further embodiment of the method, the numerical value is a cyclical redundancy check representing a portion of the alpha-numeric characters. In a further embodiment of the method, the graphic insignia is selected from the group consisting of a barcode, a two-dimensional coded data matrix, and a bokode.

A system for identification of an object having visible alpha-numeric indicia is also disclosed. The systems includes supplemental, non-alphanumeric indicia visible on the object and a camera adapted for recording the alpha-numeric indicia and the supplemental indicia to identify the object.

### DESCRIPTION OF THE DRAWINGS

FIG. 1. is a block diagram of an embodiment of an enhanced video tolling system.

### DESCRIPTION OF THE PREFERRED EMBODIMENT OF THE INVENTION

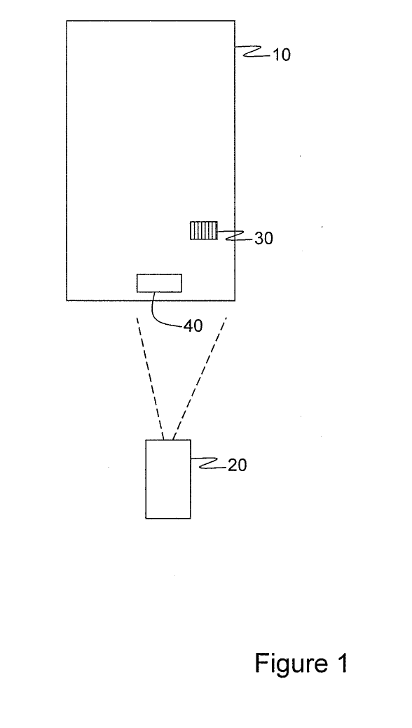

The present invention overcomes the significant disadvantages of prior art systems by providing specific information in the image that is used to cross check the plate read against specific known data that is purposely placed in the vehicle. With reference to FIG. 1, this data comes in the form of a printed surface 30 that is installed on the vehicle 10, having a license plate 40 such that its image can be captured by a video camera 20. An algorithm is then used to cross check the read plate data against this data. If the plate data and cross check data match, the odds of the plate read being incorrect is diminished significantly, and by a known mathematical factor.

This reduces the possibility of false plate reads to the point where plate reads that match the check data can be used to generate VTOLLS with a high degree of confidence. There also exists a tradeoff between the ability to read plates and false error rate. With an effective method of virtually eliminating false plate reads before they are used to VTOLL, OCR algorithms can be tuned to be more aggressive, since one can be confident that any false reads will be flagged before they cause a mis-billing. A more aggressive OCR algorithm translates into more plates being read in an automated fashion, thus further reducing manual processing required.

The check image deliberately placed on the vehicle could take various forms. In one case the check image could consist of an 8½″×11″ piece of paper printed with a series of horizontal lines, say ⅜″ wide, with a ⅜′ gap. Each line forms a bit, where a dark line represents a logical one and no line represents a zero. Such a paper would be able to represent approximately 16 bits of data in an image in this way. This paper is folded in half to form a 4¼″×11″ image and taped to the back windshield with the long side horizontal and taped to the window. The horizontal lines are now vertical on the back window, this minimizes the interference and occlusion that occurs from the typical horizontal lines that appear on a back car window due to the installation of the defroster. The plate number is then encoded digitally using ASCII coding for each of the digits of the plate. A CRC-16 is then calculated on the digital plate representation using one of the well known 16 bit polynomials used for this purpose. This process yields a 16 bit CRC which is used encoded in the paper image described above. As the vehicle passes under the toll point, the video system that reads the license plate uses the OCR but also processes the check image to recover the encoded CRC-16 data on the paper image. The recovered plate number can then be compared to the CRC-16 to validate that the read is correct. This approach reduces the number of false reads by a deterministic amount, in this case 1/65,536. If we assume that the non-checked false read rate is 1%, this leads to a checked false read rate of less than 2 per 1 million transactions, which is acceptable to most toll operators for the purpose of automated toll billing. Any plate images that do not match the CRC check can still be processed through manual review, but because more aggressive OCR techniques can now be used this number is small and has a much smaller impact on the average cost of processing a VTOLL transaction.

The above approach has the advantage that it can be implemented with a plain black and white printer. Therefore, users who want to register their plates for a VTOLL collection with an agency can do so on-line and print out the check image just as an airline passenger can check in on-line and print out a valid boarding pass. However, it can have the disadvantage that the image quality can be degraded due to the lack of retro-reflective properties typically built into license plates, and also due to reflections off the rear window, and variations in rear window construction and location. Therefore another alternative is for the toll agency to issue a decal with retro-reflective properties containing the check image. This decal is affixed to the vehicle in the vicinity of the license plate (example: on the bumper like a bumper sticker) such that both images can be obtained by the video camera system, and the same process followed as above. It should be noted that various coding schemes can be used to generate the check image. Another alternative is to print a check image on a license plate frame similar to those typically provided by auto dealers. The image might or might or might not be retro-reflective. It may also be possible to embed a low cost passive RFID transponder into the license plate frame such that the vehicle may be identified by license plate with check image or by RFID reader, or both.

In a further embodiment, the graphic insignia is two dimensional, such as a QR code or a data matrix code. In a further embodiment, the graphic insignia is a tiled series of data matrix codes such as a bokode. A bokode is a barcode design with a simple lenslet over the pattern, or the optical equivalent of that. Mohan et al. Bokode: Imperceptaible Visual Tags for Camera-Based Interaction at a Distance. Downloaded at http://cameraculture.media.mit.edu/bokode. In a further embodiment, the graphic insignia is recorded on holographic material.

As will be apparent to those skilled in the art in light of the foregoing disclosure, many alterations and modifications are possible in the practice of this invention without departing from the spirit or scope thereof. The foregoing description of preferred embodiments is by way of example, and is not intended to limit the scope of the invention in any way.

We claim:

1. An automated vehicle identification (AVI) system comprising:
a camera,
a vehicle having a graphic insignia and a license plate comprising alpha-numeric characters;
wherein said camera records both said license plate and said graphic insignia to identify the vehicle.

2. The AVI system of claim 1, wherein said graphic insignia is an encoded number derived from a portion of said alpha-numeric characters on said license plate.

3. The AVI system of claim 2, wherein said encoded number is a cyclic redundancy check of a portion of said alpha-numeric characters on said license plate.

4. The AVI system of claim 1, wherein said graphic insignia is located on said license plate.

5. The AVI system of claim 1, wherein said graphic insignia comprises a retro-reflective decal.

6. The AVI system of claim 1, wherein said graphic insignia is located inside a window of the vehicle and visible from the outside of the vehicle.

7. The AVI system of claim 1, wherein said graphic insignia is selected from the group consisting of: a barcode, a two-dimensional coded data matrix, and a bokode.

8. A method of automated toll collection comprising:
providing a vehicle with a license plate having alpha-numeric characters;
providing said vehicle with a supplemental device encoding a numeric value related to a portion of said alpha-numeric characters;
recording an image of said alpha-numeric characters with a camera;
using optical character recognition to produce an optical character recognition result from said recorded image; and
confirming said optical character recognition by comparing said optical character recognition result with said numeric value related to said portion of said alpha-numeric characters.

9. The method of claim 8, wherein said supplemental device is a graphic insignia.

10. The method of claim 8, wherein said numerical value is a cyclical redundancy check of a portion of said alpha-numeric characters.

11. The method of claim 9, wherein said graphic insignia is selected from the group consisting of a barcode, a two-dimensional coded data matrix, and a bokode.

12. A system for identification of an object having visible alpha-numeric indicia comprising;
supplemental, non-alphanumeric indicia visible on the object;
a camera adapted for recording said alpha-numeric indicia and said supplemental indicia to identify the object.
